(19) United States
(12) Patent Application Publication
(10) Pub. No.: US 2012/0212608 A1
(43) Pub. Date: Aug. 23, 2012

(54) STAR PATTERN RECORDING RECOGNITION METHOD, AND STAR SENSOR APPARATUS FOR DETERMINING SPACECRAFT ATTITUDE

(75) Inventors: Hyosang Yoon, Daejeon (KR); Hyochoong Bang, Daejeon (KR)

(73) Assignee: Korea Advanced Institute of Science and Technology, Yuseong-gu, Daejeon (KR)

(21) Appl. No.: 13/505,047

(22) PCT Filed: Sep. 27, 2010
(86) PCT No.: PCT/KR2010/006535

§ 371 Date: Apr. 30, 2012

(30) Foreign Application Priority Data
Nov. 4, 2009 (KR) 10-2009-0106183

(51) Int. Cl. G06K 9/62; H04N 7/18

(52) U.S. Cl. 348/135; 382/103; 348/E07.085

(57) ABSTRACT

The present invention relates to a star pattern recognition method and to a star sensor apparatus for determining spacecraft attitude, and more particularly, to a star pattern recognition method and to a star sensor apparatus using statistical data. According to the present invention, a star pattern recognition method for determining spacecraft attitude is provided, as well as a star sensor apparatus for the method, wherein said method comprises: an observation data acquiring step of acquiring statistical data for a first reference star in images of stars obtained from a star sensor of a spacecraft; and a pattern recognition step of searching the registered plurality of reference stars for one reference star having statistical data closest to the statistical data of the first reference star. The statistical data for the relevant star are statistical indices determined by coordinates on a standard coordinate system of stars in a region-of-interest containing said relevant star.

### TECHNICAL FIELD

The present invention relates to a star pattern recognition method and a star sensor apparatus for determining an attitude of a spacecraft, and more particularly, to a star pattern recognition method and a star sensor apparatus using statistical data.

### BACKGROUND ART

Attitude of spacecrafts including all flight vehicles, such as satellites orbiting the earth and probes leaving the earth's orbit and voyaging to distant space, need to be accurately controlled to carry out tasks. To control the attitudes of the spacecrafts, the accurate attitudes of the spacecrafts need to be determined.

Star pattern recognition technology using a star sensor is a basis for determining the attitude of a spacecraft. A star sensor is an apparatus for comparing information on a star on the celestial sphere registered in a star catalog with information on the star observed from a spacecraft to determine the attitude of the spacecraft. The star sensor provides an accuracy of several arcseconds or less with no accumulated error, in comparison with other attitude sensors. The star sensor is used not only for a task of orbiting the earth but also for a task of voyaging to distant space for an extended period.

Although the star sensor has many advantages, its use is limited by a long update period. In general, the star sensor has an update period of 1 to 2 Hz in a tracking mode, and requires 2 to 3 seconds to output a result when there is no previous attitude information. Most of the processing time is allotted to a star recognition step.

Thus far, star recognition algorithms for rapidly and robustly recognizing a star pattern have been actively researched. Most research has been intended to match geometrical positions with relationships among stars. In early research, a polygon algorithm based on angles and distances of stars in an image as characteristics of a star pattern has been most widely used (Reference Document [3]). A grid algorithm whereby grid patterns (Reference Document [4]) are matched with each other improves the robustness of a simple geometry-based approach, and has many advantages in terms of speed, memory capacity and robustness, compared to the polygon algorithm. Additionally, an algorithm modified from the initial grid algorithm has been reported for performance improvement (Reference Document [5]), and the search-less algorithm (SLA) has been proposed to increase polygon search speed (Reference Document [6]). Also, a pyramid algorithm having advantages in processing time and recognition of false stars has been installed and successfully tested (Reference Documents [7] and [8]). Further, other star recognition algorithms, such as a neural network algorithm and a genetic algorithm, using an optimization method have been proposed (Reference Documents [9] and [13]).

Most previous research fundamentally uses a pattern matching technique of comparing information on one star with information on another star (angle with angle, distance with distance, and grid with grid). Sometimes, a geometric pattern matching method requires data of adjacent stars with respect to each reference star and includes comparing the data piece by piece. Thus, the geometric pattern matching method is complicated, slow, and requires a considerable amount of on-board memory.

### DISCLOSURE

### Technical Problem

The present invention is directed to a star pattern recognition method and a star sensor apparatus having short recognition time.

The present invention is also directed to a star pattern recognition method and a star sensor apparatus whereby the amount of required memory can be reduced.

### Technical Solution

One aspect of the present invention provides a star pattern recognition method for determining an attitude of a spacecraft, including: an observation data acquisition step of acquiring statistical data for a first reference star in a star image obtained from a star sensor of the spacecraft; and a pattern recognition step of searching a plurality of registered reference stars for one reference star having statistical data closest to statistical data for the first reference star. Here, the statistical data for the star is statistical indices determined by coordinates of stars in a region-of-interest including the star on a standard coordinate system.

The statistical indices may include an average, a standard deviation, and a covariance.

The observation data acquisition step may include acquiring estimation values of statistical indices of the first reference star, and the pattern recognition step may include searching for a reference star of which a value of a cost function, which is the sum of squares of differences between the estimation values of the statistical indices of the first reference star and the corresponding statistical indices of the reference star, is the minimum.

The observation data acquisition step may include: a coordinate setting step of rearranging respective stars in the region-of-interest on the standard coordinate system; a coordinate value acquisition step of acquiring coordinate values of the respective stars in the region-of-interest on the standard coordinate system; and an observed statistical index estimation value calculation step of calculating estimation values of statistical indices using the coordinate values of the respective stars in the region-of-interest obtained in the coordinate value acquisition step.

The coordinate setting step may include: a first reference star selection step of selecting the first reference star from the image of observed stars; a region-of-interest setting step of setting the region-of-interest on the basis of the first reference star; a second reference star selection step of selecting a second reference star different from the first reference star in the region-of-interest; and a rearrangement step of rearranging the respective stars in the region-of-interest on the standard coordinate system on the basis of the first reference star and the second reference star.

The first reference star may be a star closest to the center of the image among the observed stars.

The second reference star may be a star closest to the first reference star.

The region-of-interest may be a region formed within a radius r from the first reference star.

The standard coordinate system may be an X-Y orthogonal coordinate system, and the first reference star and the second reference star may be rearranged to be placed at the origin of the standard coordinate system and on a positive X-axis line, respectively. The observed statistical indices may be ( x̅, y̅,sₓ, s_{y},s_{xy}²), and the estimation values of the observed statistical indices may be

$${x}^{Δ} = \overline{{x}^{′}}$$

$${y}^{Δ} = \overline{{y}^{′}}$$

$${\hat{s}}_{x}^{2} = {s}_{x}^{′ 2} - Var ( {n}_{x} )$$

$${\hat{s}}_{y}^{2} = {s}_{y}^{′ 2} - Var ( {n}_{y} )$$

$${\hat{s}}_{xy} = {s}_{xy}^{′} ,$$

respectively.

The pattern recognition step may include: a cost function value acquisition step of acquiring cost function values of all the registered stars; and a minimum cost function value selection step of selecting the minimum cost function value among the cost function values. Here, the cost function may be

$${J}_{k} = {( {x}^{Δ} - {\overline{x}}_{k} )}^{2} + {( {y}^{Δ} - {\overline{y}}_{k} )}^{2} + {( {\hat{s}}_{x} - {s}_{x , k} )}^{2} + {( {\hat{s}}_{y} - {s}_{y , k} )}^{2} + {( {\hat{c}}_{xy} - {c}_{xy , k} )}^{2} ,$$

and

c_{xy}=sign(s_{xy})\sqrt{abs(s_{xy})}

Another aspect of the present invention provides a star sensor apparatus for determining an attitude of a spacecraft, including: an image processor configured to convert an observed star image into digital information and output the digital information; and an attitude determiner having a memory and a central processing unit (CPU), and configured to determine the attitude of the spacecraft using the digital information on the star image. Here, the memory includes an observation data storage configured to store statistical data for a first reference star in the observed star image; and a reference data storage configured to store statistical data for a plurality of registered reference stars. The CPU calculates the statistical data for the first reference star from the digital information on the observed star image, and performs an operation of searching the plurality of registered reference stars for one reference star having statistical data closest to the statistical data for the first reference star. The statistical data for the star is statistical indices determined by coordinates of stars in a region-of-interest including the star on a standard coordinate system.

The statistical indices may include an average, a standard deviation, and a covariance.

The CPU may perform an operation of searching for a reference star of which a value of a cost function, which is the sum of squares of differences between estimation values of the statistical indices of the first reference star and the corresponding statistical indices of the reference star, is the minimum.

### Advantageous Effects

The foregoing purposes of the present invention can be achieved according to exemplary embodiments of the present invention, and detailed effects according to exemplary embodiments of the present invention are as follows.

First, a star pattern recognition method and a star sensor apparatus according to exemplary embodiments of the present invention use statistical data and thus have short recognition time.

Second, since the star pattern recognition method and a star sensor apparatus according to exemplary embodiments of the present invention require storage of statistical data for reference stars only, the amount of required memory can be reduced.

### DESCRIPTION OF DRAWINGS

FIG. 1 shows diagrams illustrating a process of establishing a standard coordinate system to calculate statistical data for a reference star.

FIG. 2 is a flowchart illustrating a star pattern recognition method according to an exemplary embodiment of the present invention.

FIG. 3 is a flowchart illustrating an observation data acquisition step shown in FIG. 2 according to an exemplary embodiment of the present invention.

FIG. 4 is a flowchart illustrating a coordinate setting step shown in FIG. 3 according to an exemplary embodiment of the present invention.

FIG. 5 is a flowchart illustrating an observed statistical index estimation value calculation step shown in FIG. 3 according to an exemplary embodiment of the present invention.

FIG. 6 is a block diagram of a star sensor apparatus according to an exemplary embodiment of the present invention.

### MODE FOR INVENTION

The present invention proposes a star pattern recognition method in which typical observation values (average and standard deviation) of a pattern are compared. A star image is regarded as points scattered in an image plane, such that two statistical observation values can be defined. Recognition of a star pattern is performed by calculating the two observation values, thus being fast and efficiently using an on-board memory. Also, the method of the present invention is robust against noise effects on a star position.

In the present invention, average, standard deviation and sample covariance are important values representing a star pattern. An average x̅ of samples x₁, x₂, . . . , and x_{N} is as follows (Reference Document [1]).

$$\overline{x} = \frac{{x}_{1} + … + {x}_{N}}{N} \qquad ( 1 )$$

Also, a standard deviation sₓ with respect to an X-axis is defined as follows

$${s}_{x}^{2} = \frac{{\sum }_{i = 1}^{N} {( {x}_{i} - \overline{x} )}^{2}}{N - 1} \qquad ( 2 )$$

A sample covariance s_{xy}² with respect to the X-axis and a Y-axis is as follows (Reference Document [1]).

$${s}_{xy} = \frac{{\sum }_{i = 1}^{N} ( {x}_{i} - \overline{x} ) ( {y}_{i} - \overline{y} )}{N - 1} \qquad ( 3 )$$

The three statistical values are well known, and generally used in various fields to represent characteristics of a given data set. Conceptually, the average represents a tendency of the data set, and the standard deviation and the covariance represent a relationship among respective items. When an average and a standard deviation are given, it is possible to determine a position that can be regarded as a characteristic of a star pattern, and the degree of scattering of a data set.

In an exemplary embodiment of the present invention, the average, standard deviation and covariance of a star image are compared with those of each star, and thereby a pattern of stars is recognized.

Prior to the detailed description of exemplary embodiments of the present invention, statistical data for a star, which is a major term used in the present invention, will be defined. Statistical data for a specific star denotes statistical indices determined by coordinates of stars in a region-of-interest including the star on a standard coordinate system. In exemplary embodiments below, a standard coordinate system denotes an X-Y orthogonal coordinate system in which the specific star is placed at the origin, and a star closest to the specific star is placed on a positive X-axis line. Thus, “statistical data for a reference star” stated below includes statistical indices determined by coordinate values of stars in a region-of-interest in an X-Y orthogonal coordinate system in which a reference star is placed at the origin, and a star closest to the reference star is placed on a positive X-axis line. Also, “statistical data for a first reference star” stated below includes statistical indices determined by coordinate values of stars in a region-of-interest in an X-Y orthogonal coordinate system in which a first reference star is placed at the origin, and a star closest to the first reference star is placed on a positive X-axis line.

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

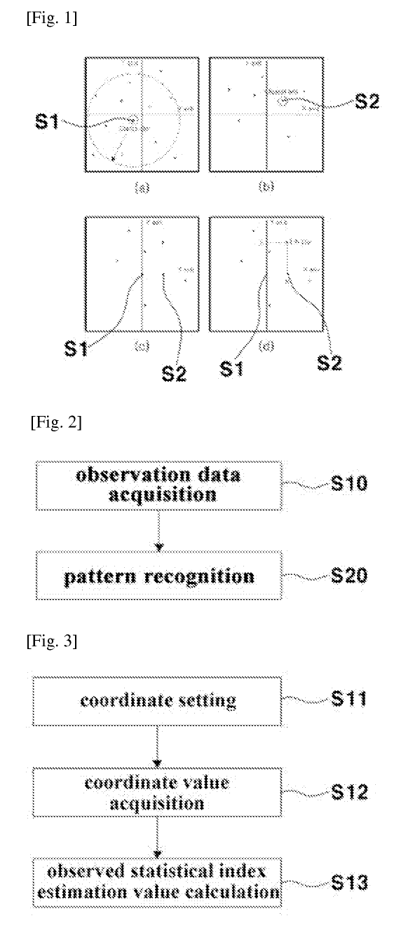

Before a star pattern recognition method according to an exemplary embodiment of the present invention is performed, statistical data for all registered reference stars needs to be generated. In this exemplary embodiment, the statistical data includes average, standard deviation and covariance. Before statistical data (average, standard deviation and covariance) for a reference star is calculated, a star image needs to be rearranged on a standard coordinate system. In essence, this is the same as a placement method in a grid algorithm (Reference Document [4]). FIG. 1 shows an example of a process of rearranging a star image on a standard coordinate system. Referring to FIG. 1, an X-Y orthogonal coordinate system in which the origin is placed at the center is established in the star image. As shown in (a) of FIG. 1, a star S1 closest to the origin of the coordinate system becomes a reference star for which statistical data is calculated. Next, as shown in (b) of FIG. 1, stars in a region-of-interest A formed within a radius r from the reference star S1 are subjected to parallel displacement to place the reference star S1 at the origin. Here, a star S2 closest to the origin of the coordinate system is selected, and placed on a positive X-axis line as shown in (c) of FIG. 1. In this state, stars in the region-of-interest have been rearranged on a standard coordinate system, and as shown in (d) of FIG. 1, coordinate values of the stars in the region-of-interest on the standard coordinate system are obtained. After the stars in the region-of-interest are rearranged on the standard coordinate system as shown in FIG. 1, average, standard deviation and covariance are calculated as follows.

$$\begin{matrix}\overline{x} = \frac{{\sum }_{i = 1}^{N} {x}_{i}}{N} & ( 4 ) \\ \overline{y} = \frac{{\sum }_{i = 1}^{N} {y}_{i}}{N} & ( 5 ) \\ {s}_{x}^{2} = \frac{{\sum }_{i = 1}^{N} {( {x}_{i} - \overline{x} )}^{2}}{N - 1} & ( 6 ) \\ {s}_{y}^{2} = \frac{{\sum }_{i = 1}^{N} {( {y}_{i} - \overline{y} )}^{2}}{N - 1} & ( 7 ) \\ {s}_{xy} = \frac{{\sum }_{i = 1}^{N} ( {x}_{i} - \overline{x} ) \cdot ( {y}_{i } - \overline{y} )}{N - 1} & ( 8 )\end{matrix}$$

According to Equation (5) to Equation (8) above, five statistical indices ( x̅, y̅,sₓ,s_{y},s_{xy}²) of each reference star in a star catalog are generated and stored as statistical data for the reference star in a memory. Statistical indices of each reference star are used to characterize a star pattern for rapid pattern recognition.

In the star pattern recognition method according to an exemplary embodiment of the present invention, calculation is performed as described above, and statistical data (average, standard deviation and covariance) for each reference star stored in the memory is used.

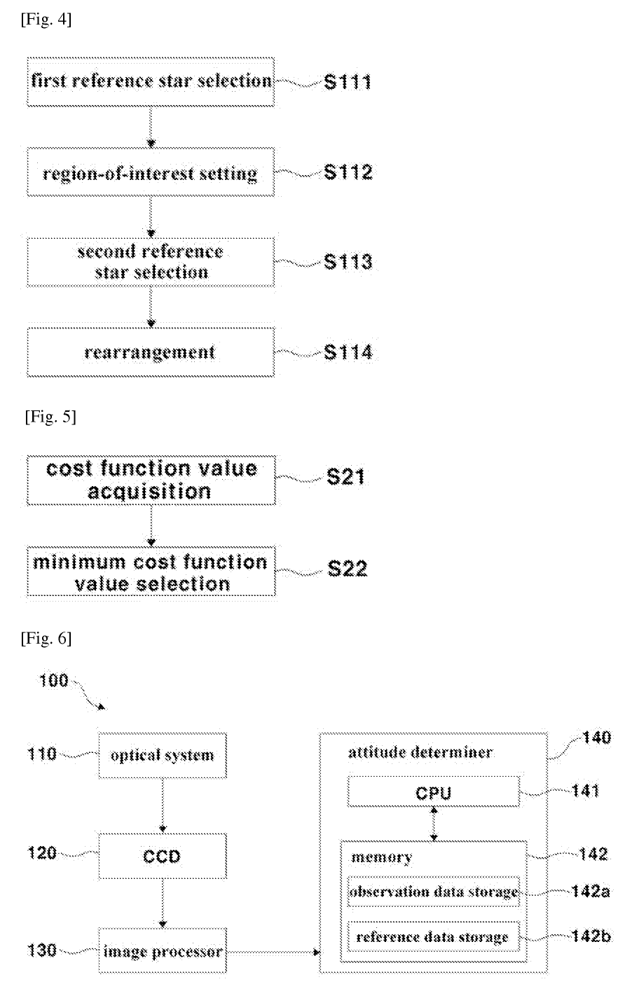

FIG. 2 is a flowchart illustrating a star pattern recognition method according to an exemplary embodiment of the present invention. FIG. 3 is a flowchart illustrating an observation data acquisition step shown in FIG. 2 according to an exemplary embodiment of the present invention, and FIG. 4 is a flowchart illustrating a coordinate setting step shown in FIG. 3 according to an exemplary embodiment of the present invention. FIG. 5 is a flowchart illustrating an observed statistical index estimation value calculation step shown in FIG. 3 according to an exemplary embodiment of the present invention.

Referring to FIG. 2, a star pattern recognition method includes an observation data acquisition step S10 and a pattern recognition step S20.

Referring to FIG. 3, the observation data acquisition step S10 includes a coordinate setting step S11, a coordinate value acquisition step S12, and an observed statistical index estimation value calculation step S13. The observation data acquisition step S10 is a step of acquiring statistical data (average, standard deviation and covariance) for a first reference star in a star image obtained from a star sensor of a spacecraft.

Referring to FIG. 4, the coordinate setting step S11 includes a first reference star selection step S111, a region-of-interest setting step S112, a second reference star selection step S113, and a rearrangement step S114. The coordinate setting step S11 is a step of rearranging each star in the region-of-interest on a standard coordinate system. The coordinate setting step S11 is the same as the process of establishing a standard coordinate system to calculate statistical data for a reference star described above with reference to FIG. 1. Thus, the respective sub-steps of the coordinate setting step S1 will be described with reference to FIG. 1.

First, in the first reference star setting step S111, a first reference star is selected from a star image observed by a star sensor. In the star image observed by the star sensor, an X-Y orthogonal coordinate system in which the origin is placed at the center is established. As shown in (a) of FIG. 1, the star S1 closest to the origin of the coordinate system is selected as a first reference star, and the star image is subjected to parallel displacement such that the first reference star S1 is placed at the origin of the coordinate system.

Next, in the region-of-interest setting step S112, the region-of-interest A is set on the basis of the first reference star S1. As shown in (a) of FIG. 1, the region-of-interest A is a region within the radius r from the first reference star S1.

Next, in the second reference star selection step S113, a second reference star is selected. As shown in (b) of FIG. 1, the star S2 closest to the origin of the coordinate system is selected as the second reference star among stars in the region-of-interest A.

Next, in the rearrangement step S114, the stars in the region-of-interest A are rearranged on the standard coordinate system. The rearrangement step S114 is performed by rotating the star image such that the second reference star S2 is placed on a positive X-axis line as shown in (c) of FIG. 1. In the state shown in (c) of FIG. 1, the stars in the region-of-interest A have been rearranged on the standard coordinate system.

The coordinate value acquisition step S12 is performed by obtaining coordinate values of the stars in the region-of-interest on the standard coordinate system as shown in (d) of FIG. 1 in the state in which the star image has been rearranged as shown in (c) of FIG. 1.

The observed statistical index estimation value calculation step S13 is a step of calculating estimation values of statistical data (average, standard deviation and covariance) for the first reference star using the coordinate values of the stars in the region-of-interest on the standard coordinate system acquired in the coordinate value acquisition step S12.

Positions of stars on a charge-coupled device (CCD) plane actually observed by a star sensor are affected by an error caused by noise, and observed coordinates of each star are as follows.

x′ₗ=xₗ+n_{x,l} (9)

y′ᵢ=yᵢ⇄n_{y,i} (10)

The average, standard deviation and covariance of an actual star image are derived with respect to the X-axis as follows, and the same with respect to the Y-axis.

$$\begin{matrix} {\overline{x}}^{′} = \frac{{\sum }_{i = 1}^{N} {x}_{1}^{′}}{N} = \frac{{\sum }_{i = 1}^{N} ( {x}_{i} + {n}_{x , i} )}{N} = \overline{x} + {\overline{n}}_{x} & ( 11 ) \\ {s}_{x}^{′ 2} = \frac{{\sum }_{i = 1}^{N} {( {x}_{i}^{′} - {\overline{x}}^{′} )}^{2}}{N - 1} = \frac{{\sum }_{i = 1}^{N} {\{ {x}_{i} + {n}_{x , i} - ( \overline{x} + {\overline{n}}_{x } ) \}}^{2}}{N - 1} = {s}_{n}^{2} + {s}_{{n}_{x}}^{2} + 2 {s}_{{xn}_{x}} & ( 12 ) \\ \begin{matrix} {s}_{xy}^{′} = \frac{{\sum }_{i = 1}^{N} ( {x}_{i}^{′} - {\overline{x}}^{′} ) ( {y}_{i}^{′} - {\overline{y}}_{i} )}{N - 1} \\ = \frac{{\sum }_{i = 1}^{N} \{ {x}_{i} + {x}_{x , i} - ( \overline{x} + {\overline{n}}_{x} ) \} \{ {y}_{i} + {n}_{y , i} - ( \overline{y} + {\overline{n}}_{y} ) \}}{N - 1} \\ = {s}_{xy} + {s}_{{xn}_{y}} + {s}_{{yn}_{x}} + {s}_{{n}_{x} {n}_{y}}\end{matrix} & ( 13 )\end{matrix}$$

Expected values of respective variables are as follows.

E[ x̅′]=E[ x̅+ n̅ₓ]= x̅+E[ n̅ₓ] (14)

$$\begin{matrix}\begin{matrix}E [ {s}_{ x}^{′2} ] = E [ {s}_{x}^{2} + {s}_{{n}_{x}}^{2} + 2 {s}_{x , {n}_{x}}^{2} ] \\ = {s}_{x}^{2} + var ( {n}_{x} ) + 2 Cov ( x , {n}_{x} )\end{matrix} & ( 15 ) \\ \begin{matrix}E [ {s}_{xy}^{′} ] = E [ {s}_{xy} + {s}_{{xn}_{y}} + {s}_{{yn}_{x} } + {s}_{{n}_{x} {n}_{y} } ] \\ = {s}_{xy} + Cov ( x , {n}_{y } ) + Cov ( y , {n}_{x} ) + Cov ( {n}_{x} , {n}_{y} )\end{matrix} & ( 16 )\end{matrix}$$

Here, Cov(a,b) denotes the covariance of a and b. Assuming that O denotes average noise having variance of which an error has been known and independent of position , the following relationship is established.

E[ n̅ₓ]=O (17)

Cov(x,nₓ)=0 (18)

Cov(x,n_{y})=0 (19)

Cov(y,nₓ)=0 (20)

Cov(nₓ,n_{y})=0 (21)

Thus, expected values of a sample average and a sample variance are as follows.

E[ x̅′]= x̅ (22)

E[s′ₓ²]=sₓ²+Var(nₓ) (23)

E[s′_{xy}]=s_{xy} (24)

Finally, as estimation values of observed statistical indices of the first reference star S1, estimation values of the average, standard deviation and covariance may be as follows.

$$\begin{matrix}{x}^{Δ} = \overline{{x}^{′}} & ( 25 ) \\ {y}^{Δ} = \overline{{y}^{′}} & ( 26 )\end{matrix}$$

ŝₓ²=s′ₓ²−Var(nₓ) (27)

ŝ_{y}²=s′_{y}²−Var(n_{y}) (28)

ŝ_{xy}=s′_{xy} (29)

The pattern recognition step S20 includes a cost function value acquisition step S21 and a minimum cost function value selection step S22. The pattern recognition step S20 is a step of searching a plurality of registered reference stars for one reference star having statistical data closest to statistical data for the first reference star.

The cost function value acquisition step S21 is a step of acquiring cost function values of all the registered stars. The cost function is defined as follows.

$${J}_{k} = {( {x}^{Δ} - {\overline{x}}_{k} )}^{2} + {( {y}^{Δ} - {\overline{y}}_{k} )}^{2} + {( {\hat{s}}_{x} - {s}_{x , k} )}^{2} + {( {\hat{s}}_{y} - {s}_{y , k} )}^{2} + {( {\hat{c}}_{xy} - {c}_{xy , k} )}^{2} \qquad ( 30 )$$

Here, the fourth covariance term c_{xy} is introduced to cause a unit to match an order of cost while maintaining characteristics of covariance.

c_{xy}=sign(s_{xy})\sqrt{abs(s_{xy}′)} (31).

Here, sign( )and abs( )denote a signum function and an absolute value, respectively. The subscript k denotes a k-th reference star of a star catalog. The minimum cost function value selection step S22 is a step of selecting the minimum cost function value among cost function values. According to the least squares principle (Reference Documents [19] and [20]), a reference star having the minimum value of the cost function is recognized to correspond to the first reference star. Finally, an attitude is determined according to a direction and the amount of the movement (parallel displacement and rotation) of the image performed in the coordinate setting step S11.

To examine the recognition performance of the star pattern recognition method according to an exemplary embodiment of the present invention, many simulations were performed under high noise conditions. An algorithm did not use luminosity information but used only the position error of each star. To describe an improvement in performance, a comparison with the initial grid algorithm, which was famous and well known for its performance and efficiency, was made.

A bright star catalog (BSC) containing 9110 stars was used as a reference star catalog. 9021 stars that are not too close to each other and have a luminosity of less than 6.5 were used for a star tracker. For the convenience of the grid algorithm, only 5,005 stars having a luminosity of less than 6 were used for these simulations. A grid size was 50×50, which is not sufficient for an actual star sensor but is generally used to evaluate the performance of the grid algorithm. A region-of-interest (r of FIG. 1, not a view region) and a CCD resolution of these simulations were 10×10 deg and 512×512 pixels, respectively.

In a noisy environment, the position of each star on an image plane is affected by an error. To describe accurate performance for a position error, the error is added as a Gaussian random noise for which 3 σ is 0 to 3 pixels with respect to an X-axis and a Y-axis, respectively. The unit of the error is a CCD pixel corresponding to 70.31 arcseconds. Each simulation was conducted 100,000 times. Table 1 shows the simulation results.

TABLE 1
Recognition ratio according to position error

| | Recognition ratio | |
|---|---|---|
| Position error (pixels) | Present invention (%) | Grid algorithm (%) |
| 0 | 98.48 | 96.95 |
| 0.5 | 96.80 | 95.87 |
| 1 | 95.25 | 92.91 |
| 1.5 | 93.65 | 89.77 |
| 2 | 91.85 | 86.63 |
| 2.5 | 90.24 | 82.84 |
| 3 | 88.50 | 80.01 |

As shown in the results, while the grid algorithm has a recognition ratio from 80.01% to 96.95%, the star pattern recognition method according to an exemplary embodiment of the present invention has a recognition ratio of 88% or higher. As for a commercial star tracker, the star position error is generally less than 0.5 pixels. Thus, it is possible to know that the star pattern recognition method according to an exemplary embodiment of the present invention is at least more robust against the position error than the grid algorithm is.

All the simulations were conducted using an AMD phenom II 3.2 GHz desktop computer. All program codes were written in C language, and compiled with Microsoft Visual Studio 2008. Processing time was measured in recognition simulations 700,000 times. The simulation results are shown in Table 2.

TABLE 2
Recognition time

| | Simulation time | |
|---|---|---|
| | Present invention | |
| Number of simulations | (seconds) | Grid algorithm (seconds) |
| 700,000 | 88.2595 | 21718.429 |

Table 3 includes recognition time for one star. According to the results, the star pattern recognition method according to an exemplary embodiment of the present invention is 240 times faster than the grid algorithm. Although the star pattern recognition method according to an exemplary embodiment of the present invention involves some arithmetic operations such as multiplication and a square root, a comparison of only four statistical indices such as average and standard deviation is made. Thus, the star pattern recognition method according to an exemplary embodiment of the present invention is much faster than the grid algorithm in which all of the 50×50 grids are compared and counted.

TABLE 3
Recognition time
Recognition time

| Present invention (seconds) | Grid algorithm (seconds) |
|---|---|
| 0.126 × 10⁻³ | 31.026 × 10⁻³ |

In an actual star sensor, the star pattern recognition method according to an exemplary embodiment of the present invention is much faster than the existing grid algorithm. In the star pattern recognition method according to an exemplary embodiment of the present invention, recognition time is proportional to the number of reference stars. On the other hand, the grid algorithm is proportional to the number of stars and the grid size.

For example, when the luminosity of reference stars is less than 6.5, the number of the reference stars becomes 9,021. In this case, a grid size of 80×80 to 100×100 is generally used. Recognition time for the 50×50 grid size is 2.56 times longer than that for the 40×40 grid size. Thus, the star pattern recognition method according to an exemplary embodiment of the present invention is estimated to be 600 times or more faster than the grid algorithm.

In the star pattern recognition method according to an exemplary embodiment of the present invention, five pieces of float data are required for one reference star. Since a float is 4 bytes, 20N bytes are required for reference data. Here, N is the number of reference stars. In the grid algorithm, one grid is stored as one bit, and NG²/8 bytes are required. Here, G is the size of a grid pattern. Table 4 shows the amount of memory required for each case.

TABLE 4
Required memory

| | Required memory | | |
|---|---|---|---|
| Number of | Present invention | 50 × 50 grid | 80 × 80 grid |
| reference stars | (bytes) | algorithm (bytes) | algorithm (bytes) |
| 1596 | 31,920 | 494,063 | 1,276,800 |
| 5005 | 100,100 | 1,551,250 | 4,004,000 |
| 9021 | 180,420 | 2,784,688 | 7,216,800 |

Thus, the star pattern recognition method according to an exemplary embodiment of the present invention uses only 1/15 of the amount of memory used by the grid algorithm. Since a memory access speed includes the improved calculation speed of the star pattern recognition method according to an exemplary embodiment of the present invention, the required memory size also has influence on the recognition speed.

The star pattern recognition method according to an exemplary embodiment of the present invention having gone through a robustness test shows higher process speed and requires a smaller amount of memory, such that the star pattern recognition method can be considered to be able to be actually installed and executed in a spacecraft and practically accessible in recognition of a star pattern.

Compared to the existing grid algorithm, the star pattern recognition method according to an exemplary embodiment of the present invention based on average, standard deviation and sample covariance, which are statistical values, provides improved performance in some aspects. In the star pattern recognition method according to an exemplary embodiment of the present invention, a star pattern is recognized on the basis of average, standard deviation and sample covariance, which are three simple statistical standards of the positions of stars on an image. Through extensive simulation research, it is proved that the star pattern recognition method according to an exemplary embodiment of the present invention is more robust against position error, faster, and more efficient in memory use than the grid algorithm.

FIG. 6 is a block diagram of a star sensor apparatus according to an exemplary embodiment of the present invention that performs the above-described star pattern recognition method. Referring to FIG. 6, a star sensor apparatus 100 includes an optical system 110, a CCD 120, an image processor 130 and an attitude determiner 140. The optical system 110 concentrates optical energy of a star having a relatively small quantity of light. The CCD 120 senses an image of a star passed through the optical system 110. The image processor 130 converts the image of the star sensed by the CCD 120 into digital information, and transfers the data to the attitude determiner 140.

The attitude determiner 140 includes a central processing unit (CPU) 141 and a memory 142. The attitude determiner 140 processes the digital information on the star image received from the image processor 130 and determines the attitude of a spacecraft.

Using data stored in the memory 142, the CPU 141 performs the observation data acquisition step S10 and the pattern recognition step S20 described in detail above with reference to FIG. 2. In other words, after converting the star image received from the image processor 130 and stored in the memory 142 into coordinate values on a standard coordinate system, the CPU 141 calculates statistical data for a first reference star and stores estimation values of the statistical data in the memory 142. Also, the CPU 141 performs an operation of searching for a reference star of which a value of a cost function, which is the sum of squares of differences between estimation values of statistical indices of the first reference star stored in the memory 142 and the corresponding statistical indices of the reference star stored in the memory 142, is the minimum.

The memory 142 includes an observation data storage 142a and a reference data storage 142b. In the observation data storage 142a, the star image obtained through the star sensor and information on the statistical data for the first reference star are stored. In the reference data storage 142b, statistical data for all registered reference stars is stored.

While the invention has been shown and described with reference to certain exemplary embodiments thereof, it will be understood by those skilled in the art that various changes in form and details may be made therein without departing from the spirit and scope of the invention as defined by the appended claims.

### References—

[1] Hayter, A. J, Probability & Statistics For Engineers & Scientist, 2nd Edition, Thomson Business Information, 2002.

[2] Spratling, B. B, Mortari, D., “A Survey on Star Identifications Algorithms”, Algorithms, 2009, 2, pp. 93-107.

[3] Junkins, J. L., White, C., Turner, J., “Star pattern recognition for real-time attitude determination”, Journal of the Astronautical ciences, 1977, 25, pp. 251-270.

[4] Padgett. C., Kreutz-Delgado. K, “A grid algorithm for star identification”, IEEE

Transactions on Aerospace and Electronics Systems, 31, 1, 1997, pp. 202-213.

[5] Na, M., Zheng, D., Jia, P., “Modified Grid Algorithm for Noisy All-Sky Autonomous Star Identification”, IEEE Transactions on Aerospace and Electronics Systems, 45, 2(April 2009), 516-522.

[6] Mortari, D., “Search-less algorithm for star pattern recognition”, Journal of the Astronautical Sciences, Vol. 45, No. 2, 1997, pp. 179-194.

[7] Mortari, D., Neta, B., “K-vector range searching techniques”, Paper AAS 00-128 of the 10th Annual AIAA/AAS Space Flight Mechanics meeting, Clearwaters, Fla., 2000.

[8] Mortari, D., Junkins, J. L., Samman, M. A., “Lost-in-space pyramid algorithm for robust star pattern recognition”, Paper AAS 01-004 Guidance and Control Conference, Breckenridge, Colo., 2001.

[9] Lindsey, C. S., Lindblad, T., Eide, A. J., “Method for star identification using neural networks”, In Proceedings of SPIE International Society of Optical Engineering, 1997, 471-478.

[10] Kim, K. T., Bang, H., “Reliable star pattern identification technique by using neural networks”, Journal of the Astronautical Sciences, 52, 1-2(January-June 2004), 239-249.

[11] Hong, J., Dicjerson, J. A., “Neural-Network-based autonomous star identification algorithm”, AIAA Journal of Guidance, Control & Dynamics, 2000, 23, pp. 728-735.

[12] Servidia, P. A., Sanchez Pena, P. S., “New robust star identification algorithm”, IEEE Transactions on Aerospace and Electronics Systems, 42, 3 (July 2006), 1126-1131.

[13] Paladugu, L., Williams, B. G., Schoen, M. P., “Star pattern recognition for attitude determination using genetic algorithm”, Presented at the 17th AIAA/USU Conference on Small Satellites, August 2004.

[14] Lamy Au Rousseau, G., Bostel, J., Mazari, B., “Star recognition algorithm for APS star tracker: oriented triangles”, IEEE Transactions on Aerospace and Electronics Systems, 20, 2, 2005, pp. 27-31.

[15] Samman, M. A., Mortari, D., Junkins, J. L., “Resursive mode star identification algorithms”, IEEE Transactions on Aerospace and Electronics Systems, 41, 4, 2005, pp. 1246-1254.

[16] Xie, J., Jiang, W., Gong, J., “A New Star Identification Algorithm based on Matching Probability”, Geoscience and Remote Sensing Symposium, 2008. IGARSS. IEEE International, 3, 2008, pp. 166-1169.

[17] Udomkesmalee, S., Alexander, J. W., Tolivar, A. F., “Stochastic star identification”, AIAA Journal of Guidance, Control & Dynamics, 1994, pp. 1283-1286.

[18] Silani, E., Lovera, E., “Star identification algorithms: nocel approach & comparison study”, IEEE Transactions on Aerospace and Electronics Systems, 42, 4, 2006, pp. 1275-1288.

[19] Simon, D., Optimal State Estimation, Wiley-Interscience, 2006.

[20] C. Gauss, Theory of Motion of the Heavenly Bodies Moving About the Sun in Conic Sections: A Translation of Theoria Motus, Dover, N.Y., 2004.

1. A star pattern recognition method for determining an attitude of a spacecraft, comprising:
an observation data acquisition step of acquiring statistical data for a first reference star in a star image obtained from a star sensor of the spacecraft; and
a pattern recognition step of searching a plurality of registered reference stars for one reference star having statistical data closest to statistical data for the first reference star,
wherein the statistical data for the star is statistical indices determined by coordinates of stars in a region-of-interest including the star on a standard coordinate system.

2. The star pattern recognition method of claim 1, wherein the statistical indices include an average, a standard deviation, and a covariance.

3. The star pattern recognition method of claim 1, wherein the observation data acquisition step includes acquiring estimation values of statistical indices of the first reference star, and
the pattern recognition step includes searching for a reference star of which a value of a cost function, which is a sum of squares of differences between the estimation values of the statistical indices of the first reference star and the corresponding statistical indices of the reference star, is a minimum.

4. The star pattern recognition method of claim 1, wherein the observation data acquisition step includes:
a coordinate setting step of rearranging respective stars in the region-of-interest on the standard coordinate system;
a coordinate value acquisition step of acquiring coordinate values of the respective stars in the region-of-interest on the standard coordinate system; and
an observed statistical index estimation value calculation step of calculating estimation values of statistical indices using the coordinate values of the respective stars in the region-of-interest obtained in the coordinate value acquisition step.

5. The star pattern recognition method of claim 4, wherein the coordinate setting step includes:
a first reference star selection step of selecting the first reference star from the image of observed stars;
a region-of-interest setting step of setting the region-of-interest on the basis of the first reference star;
a second reference star selection step of selecting a second reference star different from the first reference star in the region-of-interest; and
a rearrangement step of rearranging the respective stars in the region-of-interest on the standard coordinate system on the basis of the first reference star and the second reference star.

6. The star pattern recognition method of claim 5, wherein the first reference star is a star closest to a center of the image among the observed stars.

7. The star pattern recognition method of claim 5, wherein the second reference star is a star closest to the first reference star.

8. The star pattern recognition method of claim 5, wherein the region-of-interest is a region formed within a radius r from the first reference star.

9. The star pattern recognition method of claim 5, wherein the standard coordinate system is an X-Y orthogonal coordinate system, and
the first reference star and the second reference star are rearranged to be placed at an origin of the standard coordinate system and on a positive X-axis line, respectively.

10. The star pattern recognition method of claim 9, wherein the observed statistical indices are ( x̅, y̅, sₓ, s_{y}, s_{xy}²).

11. The star pattern recognition method of claim 10, wherein the estimation values of the observed statistical indices are
$${x}^{Δ} = \overline{{x}^{′}}$$
$${y}^{Δ} = \overline{{y}^{′}}$$
ŝₓ²=s′ₓ²−Var(nₓ)
ŝ_{y}²=s′_{y}²−Var(n_{y})
ŝ_{xy}=s′_{xy} (29)
respectively.

12. The star pattern recognition method of claim 10, wherein the pattern recognition step includes:
a cost function value acquisition step of acquiring cost function values of all the registered stars; and
a minimum cost function value selection step of selecting a minimum cost function value among the cost function values,
wherein the cost function is
$${J}_{k} = {( {x}^{Δ} - {\overline{x}}_{k } )}^{2} + {( {y}^{Δ} - {\overline{y}}_{k} )}^{2} + {( {\hat{s}}_{x} - {s}_{x , k} )}^{2} + {( {\hat{s}}_{y} - {s}_{y , k} )}^{2} + {( {\hat{c}}_{xy} - {c}_{xy , k} )}^{2} ,$$
and
c_{xy}=sign(s_{xy})\sqrt{abs(s_{xy})}.

13. A star sensor apparatus for determining an attitude of a spacecraft, comprising:
an image processor configured to convert an observed star image into digital information and output the digital information; and
an attitude determiner having a memory and a central processing unit (CPU), and configured to determine the attitude of the spacecraft using the digital information on the star image,
wherein the memory includes an observation data storage configured to store statistical data for a first reference star in the observed star image, and a reference data storage configured to store statistical data for a plurality of registered reference stars,
the CPU calculates the statistical data for the first reference star from the digital information on the observed star image, and performs an operation of searching the plurality of registered reference stars for one reference star having statistical data closest to the statistical data for the first reference star, and
the statistical data for the star is statistical indices determined by coordinates of stars in a region-of-interest including the star on a standard coordinate system.

14. The star sensor apparatus of claim 13, wherein the statistical indices include an average, a standard deviation, and a covariance.

15. The star sensor apparatus of claim 13, wherein the CPU performs an operation of searching for a reference star of which a value of a cost function, which is a sum of squares of differences between estimation values of the statistical indices of the first reference star and the corresponding statistical indices of the reference star, is a minimum.
